(19) United States
(12) Patent Application Publication
(10) Pub. No.: US 2026/0045976 A1
(43) Pub. Date: Feb. 12, 2026

(54) EXPLICIT CHANNEL FEEDBACK TO ENABLE MULTI-USER MULTIPLE-INPUT MULTIPLE-OUTPUT (MU-MIMO) COMMUNICATIONS

(71) Applicant: QUALCOMM Incorporated, San Diego, CA (US)

(72) Inventors: Vasanthan RAGHAVAN, West Windsor Township, NJ (US); Juergen CEZANNE, Ocean Township, NJ (US); Yu ZHANG, San Diego, CA (US); Jing SUN, San Diego, CA (US); Jing JIANG, San Diego, CA (US)

(21) Appl. No.: 18/800,968

(22) Filed: Aug. 12, 2024

(51) Int. Cl. H04B 7/0452

(52) U.S. Cl. CPC H04B 7/0452

(57) ABSTRACT

Various aspects of the present disclosure generally relate to wireless communication, and to channel feedback for multi-user multiple-input-multiple output (MU-MIMO) communications. For example, the present disclosure provides techniques for explicit channel feedback at an analog beam level for a MU-MIMO system. In some aspects, a user equipment (UE) receives, via an analog receiving beam, reference signals transmitted by a network node via a plurality of analog beams. Based on the received reference signals, the UE determines channel impulse response (CIR) values for each frequency component of one or more frequency components of a frequency range, and transmits CIR information that indicates at least one CIR value to the network node. In another aspect, the network node uses the CIR information to co-schedule multiple UEs for MU-communications, determine one or more beams to be used by the multiple UEs for their MU-MIMO communications, or a combination thereof.

### FIELD OF THE DISCLOSURE

Aspects of the present disclosure relate generally to wireless communication systems, and more particularly, to explicit channel feedback for multi-user multiple-input-multiple output (MU-MIMO) communications in wireless communication systems, such as analog beamforming channel feedback for MU-MIMO transmission.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In a multi-user multiple-input-multiple output (MU-MIMO) system, channel state feedback, such as channel state information (CSI), is typically provided by a user equipment (UE) at a digital beamforming level in accordance with a Type-II codebook. For example, the UE may determine a preferred set of precoders based on a codebook of beamforming vectors and provide, to the network, implicit channel feedback that indicates the preferred set of precoders. The channel feedback received by the network is typically specific to the UE and wireless communications according to the preferred set of precoders for the UE may cause interference with wireless communications for another UE having a different preferred set of precoders. To avoid such interference, the network can schedule communications for the MU-MIMO system to account for multiuser interference between different preferred precoders of multiple UEs by assigning non-interfering sets of precoders to the multiple UEs. However, because the network has no insight into the full channel matrix information associated with each UE, the network does not know if alternate precoders (that are different from the reported set of preferred precoders) for the UEs are suitable given channel conditions experienced by the UEs. Therefore, the network has limited flexibility to simultaneously schedule the multiple UEs to resolve multiuser interference. The lack of flexibility to simultaneously schedule multiple UEs in the MU-MIMO system can negatively impact an achievable communication rate for MU-MIMO communication in the MU-MIMO system.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a user equipment (UE) for wireless communication. The UE includes a processing system that includes one or more processors and one or more memories coupled with the one or more processors. The processing system is configured to cause the UE to receive, from a network node via a plurality of analog beams, a plurality of reference signals. The processing system is further configured to cause the UE to obtain, for each frequency component of one or more frequency components of a frequency range, a respective set of channel impulse response (CIR) values associated with the received plurality of reference signals. Each frequency component spans a bandwidth of a channel between the network node and the UE. The processing system is also configured to cause the UE to transmit, to the network node, a message that includes, for at least one frequency component of the frequency range, at least one CIR value of the set of CIR values associated with the frequency component. The processing system is configured to cause the UE to receive, from the network node, multi-user multiple-input multiple-output (MU-MIMO) configuration information in accordance with the message.

Some aspects described herein relate to a method of wireless communication performed by a UE. The method includes receiving, from a network node via a plurality of analog beams, a plurality of reference signals. The method further includes obtaining, for each frequency component of one or more frequency components of a frequency range, a set of CIR values associated with the received plurality of reference signals. Each frequency component spans a bandwidth of a channel between the network node and the UE. The method also includes transmitting, to the network node, a message that includes, for at least one frequency component of the frequency range, at least one CIR value of the set of CIR values associated with the frequency component. The method includes receiving, from the network node, MU-MIMO configuration information in accordance with the message.

Some aspects described herein relate to an apparatus. The apparatus includes means for receiving, from a network node via a plurality of analog beams, a plurality of reference signals. The apparatus further includes means for obtaining, for each frequency component of one or more frequency components of a frequency range, a set of CIR values associated with the received plurality of reference signals. Each frequency component spans a bandwidth of a channel between the network node and the UE. The apparatus also includes means for transmitting, to the network node, a message that includes, for at least one frequency component of the frequency range, at least one CIR value of the set of CIR values associated with the frequency component. The apparatus includes means for receiving, from the network node, MU-MIMO configuration information in accordance with the message.

Some aspects described herein relate to a non-transitory computer-readable medium that stores instructions that, when executed by one or more processors, cause the one or more processors to perform operations. The operations include receiving, from a network node via a plurality of analog beams, a plurality of reference signals. The operations also include obtaining, for each frequency component of one or more frequency components of a frequency range, a set of CIR values associated with the received plurality of reference signals. Each frequency component spans a bandwidth of a channel between the network node and the UE. The operations further include transmitting, to the network node, a message that includes, for at least one frequency component of the frequency range, at least one CIR value of the set of CIR values associated with the frequency component. The operations include receiving, from the network node, MU-MIMO configuration information in accordance with the message.

Some aspects described herein relate to a network node for wireless communication. The network node includes a processing system that includes one or more processors and one or more memories coupled with the one or more processors. The processing system is configured to cause the network node to transmit, via a plurality of analog beams, a plurality of reference signals. The processing system is further configured to receive, from a UE, a message that includes, for at least one frequency component of one or more frequency components of a frequency range, at least one CIR value associated with the frequency component. Each frequency component of the one or more frequency components spans a bandwidth of a channel between the network node and the UE. The at least one CIR value is obtained by the UE in association with the plurality of reference signals. The processing system is also configured to transmit, to the UE, MU-MIMO configuration information in accordance with the message.

Some aspects described herein relate to a method of wireless communication performed by a network node. The method includes transmitting, via a plurality of analog beams, a plurality of reference signals. The method further includes receiving, from a UE, a message that includes, for at least one frequency component of one or more frequency components of a frequency range, at least one CIR value associated with the frequency component. Each frequency component of the one or more frequency components spans a bandwidth of a channel between the network node and the UE. The at least one CIR value is obtained by the UE in association with the plurality of reference signals. The method also includes transmitting, to the UE, MU-MIMO configuration information in accordance with the message.

Some aspects described herein relate to an apparatus. The apparatus includes means for transmitting, via a plurality of analog beams, a plurality of reference signals. The apparatus further includes means for receiving, from a UE, a message that includes, for at least one frequency component of one or more frequency components of a frequency range, at least one CIR value associated with the frequency component. Each frequency component of the one or more frequency components spans a bandwidth of a channel between the network node and the UE. The at least one CIR value is obtained by the UE in association with the plurality of reference signals. The apparatus also includes means for transmitting, to the UE, MU-MIMO configuration information in accordance with the message.

Some aspects described herein relate to a non-transitory computer-readable medium that stores instructions that, when executed by one or more processors, cause the one or more processors to perform operations. The operations transmitting, via a plurality of analog beams, a plurality of reference signals. The operations also include receiving, from a UE, a message that includes, for at least one frequency component of one or more frequency components of a frequency range, at least one CIR value associated with the frequency component. Each frequency component of the one or more frequency components spans a bandwidth of a channel between the network node and the UE. The at least one CIR value is obtained by the UE in association with the plurality of reference signals. The operations further include transmitting, to the UE, MU-MIMO configuration information in accordance with the message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports channel feedback for multi-user multiple-input-multiple output (MU-MIMO) communications in accordance with the present disclosure.

FIG. 5 includes diagrams illustrating aspects of another example of a wireless communication system that supports channel feedback for MU-MIMO communications in accordance with the present disclosure.

FIG. 6 is a flow diagram illustrating an example process that supports channel feedback for MU-MIMO communications in accordance with the present disclosure.

FIG. 7 is a block diagram of an example UE that supports channel feedback for MU-MIMO communications in accordance with the present disclosure.

FIG. 8 is a flow diagram illustrating an example process that supports channel feedback for MU-MIMO communications in accordance with the present disclosure.

FIG. 9 is a block diagram of an example network node that supports channel feedback for MU-MIMO communications in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for channel feedback for multi-user multiple-input-multiple output (MU-MIMO) communications for wireless communication systems. Some aspects more specifically relate to explicit channel feedback provided by a user equipment (UE) to a network node to enable the network node to determine UE scheduling information, beam allocation information for MU-MIMO communications, or both, for the UE. In some aspects, the network node transmits reference signals via a set of multiple analog beams that have a unitary or near-unitary property, such as the analog beams spanning a full dimensionality of an eigenspace or beamspace of the network node as seen from its antenna elements. The UE receives the reference signals via an analog receive beam and determines, for each frequency component of one or more frequency components of a frequency range, a respective set of channel impulse response (CIR) values associated with the received reference signals. The UE transmits an indication of at least one value of a set of the CIR values to the network node as the explicit channel feedback at an analog beam level, which provides the network node with information that improves scheduling flexibility and communication in a MU-MIMO system.

Particular implementations of the subject matter described in this disclosure can be implemented to realize one or more of the following potential advantages. In some aspects, the present disclosure provides techniques for increasing an available communication rate for MU-MIMO communication in a MU-MIMO system by providing explicit channel feedback to a network node that enables flexibility in scheduling multiple UEs for concurrent MU-MIMO communications. For example, the explicit channel feedback received by the network node includes one or more CIR values associated with a coherence bandwidth of a channel between the UE and the network node, which provides the network node with an ability to determine explicitly a channel matrix for the UE that enables the network node to co-schedule the UE with other UEs for MU-communications and determine one or more beams to be used by the multiple UEs for their MU-MIMO communications that avoids interference between the multiple UEs. The explicit channel feedback at the analog beam level results enables the network node to perform co-scheduling and beam selection that provides a higher achievable communication rate for MU-MIMO communication in the MU-MIMO system, as compared to conventional MU-MIMO channel state feedback that is provided at a digital beamforming level in accordance with a Type-II codebook.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

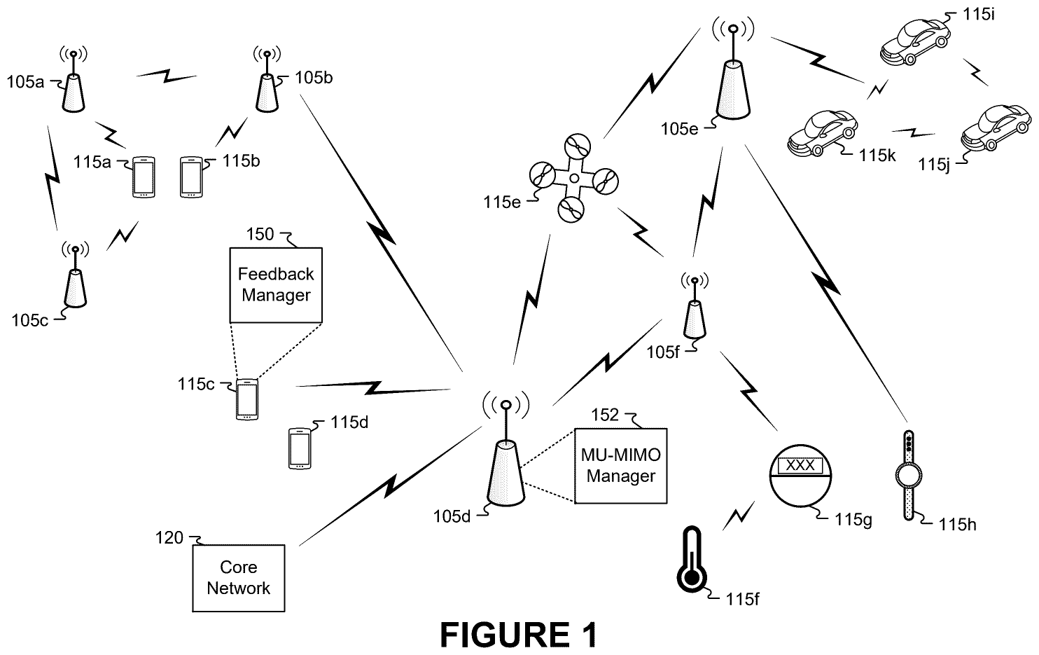

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

The wireless communication network 100 illustrated in FIG. 1 includes multiple network nodes 105, also referred to as network entities, and multiple user equipments (UEs) 115. A network node may be a station that communicates with UEs and may be referred to as a base station, an evolved node B (eNB), a next generation eNB (gNB), an access point, and the like. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 115 and a core network 120 of the wireless communication network 100.

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture. In some deployments, disaggregated network nodes 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of a network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit downlink control information (DCI) (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in a UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as MU-MIMO. Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (CoMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

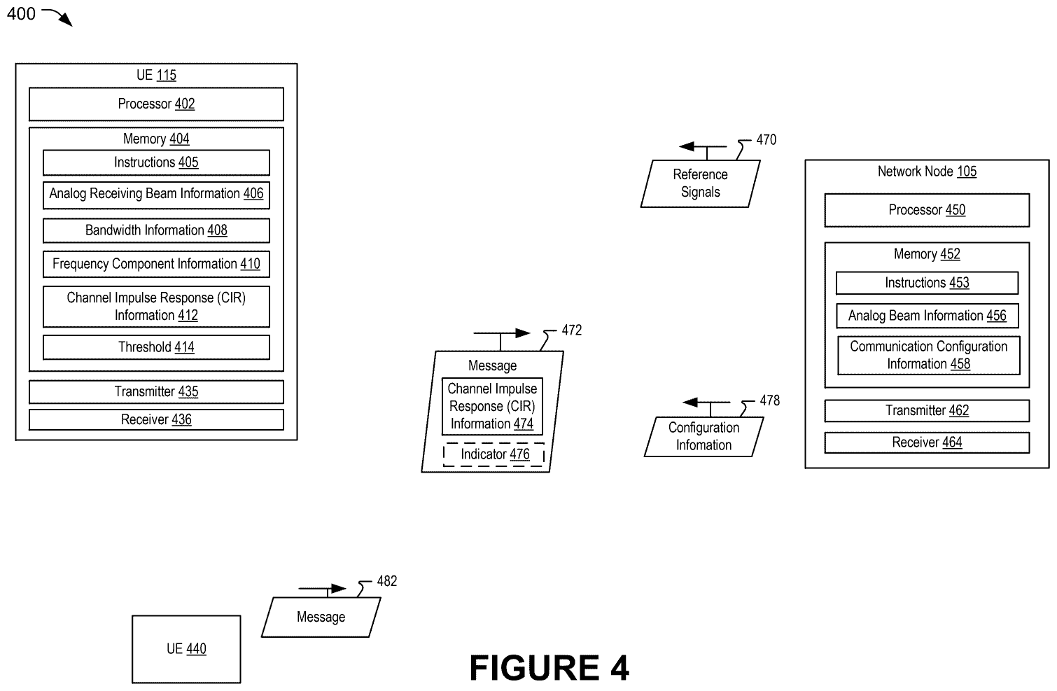

In some aspects, one or more of the network nodes 105 and one or more of the UEs may perform wireless communications that support channel feedback for MU-MIMO communications. For example, one or more of the UEs 115 (such as the UE 115c) may include a feedback manager 150 and one or more of the network nodes 105 (such as the network node 105d) may include a MU-MIMO manager 152 that manage operations that support channel feedback for MU-MIMO communications. The operations of the feedback manager 150 may include receiving, from the network node 105 via a plurality of analog beams, a plurality of reference signals; obtaining, for each frequency component of one or more frequency components of a frequency range, a set of CIR values associated with the received plurality of reference signals, where each frequency component spans a coherence bandwidth of a channel between the network node 105 and the UE 115; transmitting, to the network node, a message that includes, for at least one frequency component of the frequency range, at least one CIR value of the set of CIR values associated with the frequency component; and receiving, from the network node, MU-MIMO configuration information in accordance with the message, as further described herein with reference to FIG. 4. The operations of the MU-MIMO manager 152 may include transmitting, via a plurality of analog beams, a plurality of reference signals; receiving, from the UE 115, a message that includes, for at least one frequency component of one or more frequency components of a frequency range, at least one CIR value associated with the frequency component, where each frequency component of the one or more frequency components spans a coherence bandwidth of a channel between the network node 105 and the UE 115, and where the at least one CIR value is obtained by the UE 115 in association with the plurality of reference signals; and transmitting, to the UE 115, MU-MIMO configuration information in accordance with the message, as further described herein with reference to FIG. 4.

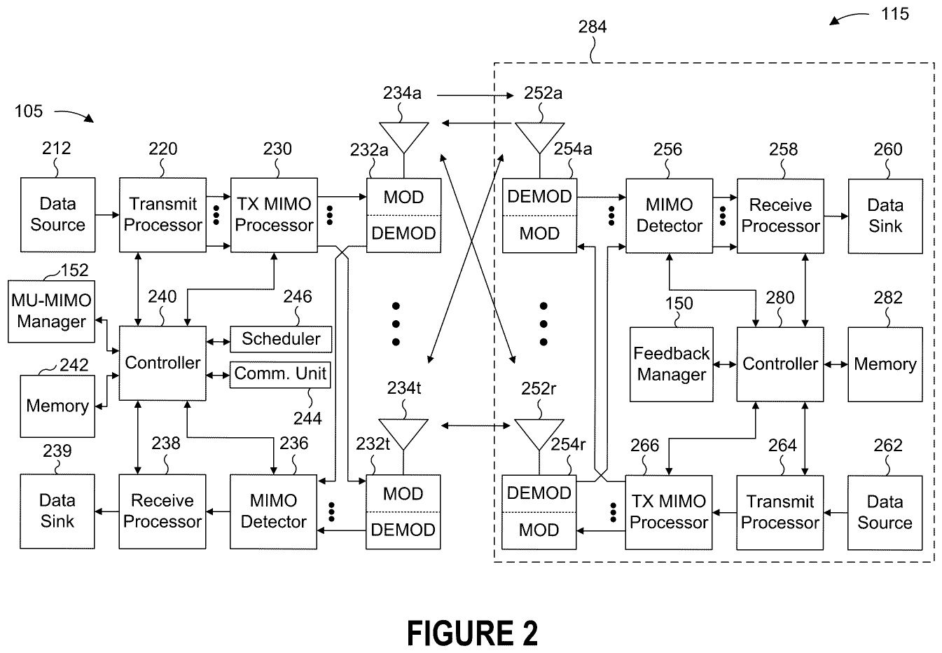

FIG. 2 is a block diagram illustrating examples of a network node 105 and a UE 115 in accordance with the present disclosure. The network node 105 and the UE 115 may be one of the network nodes 105 and one of the UEs 115 in FIG. 1. For a restricted association scenario (as mentioned above), the network node 105 may be the small cell network node 105f in FIG. 1, and the UE 115 may be the UE 115c or 115d operating in a service area of the network node 105f, which in order to access the small cell network node 105f, would be included in a list of accessible UEs for the small cell network node 105f. Additionally, the network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by MIMO detector 236 if applicable, and further processed by receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

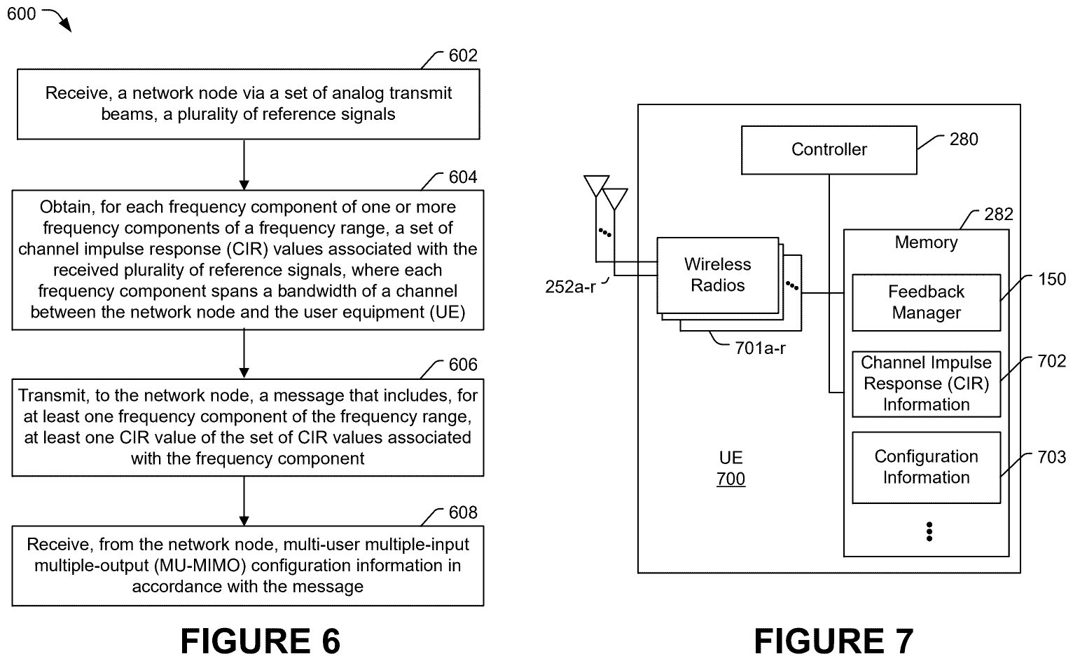

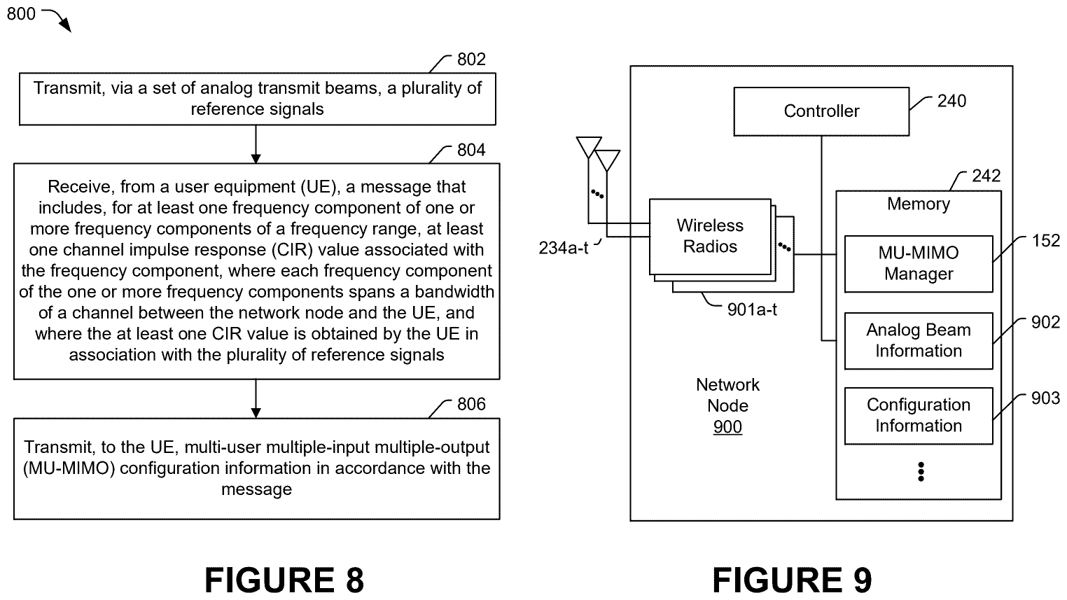

The controllers 240 and 280 may direct the operation at the network node 105 and the UE 115, respectively. The controller 240 (or other processors and modules at the network node 105) or the controller 280 (or other processors and modules at the UE 115) may perform or direct the execution of various processes for the techniques described herein, such as to perform or direct the execution illustrated in FIGS. 6 and 8, or other processes for the techniques described herein. For example, the controller 240 and/or the controller 280 may perform or control operations that support channel feedback for MU-MIMO communications. Additionally, or alternatively, the UE 115 may include the feedback manager 150 and the network node 105 may include the MU-MIMO manager 152 that manage operations to support channel feedback for MU-MIMO communications, as further described herein. Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

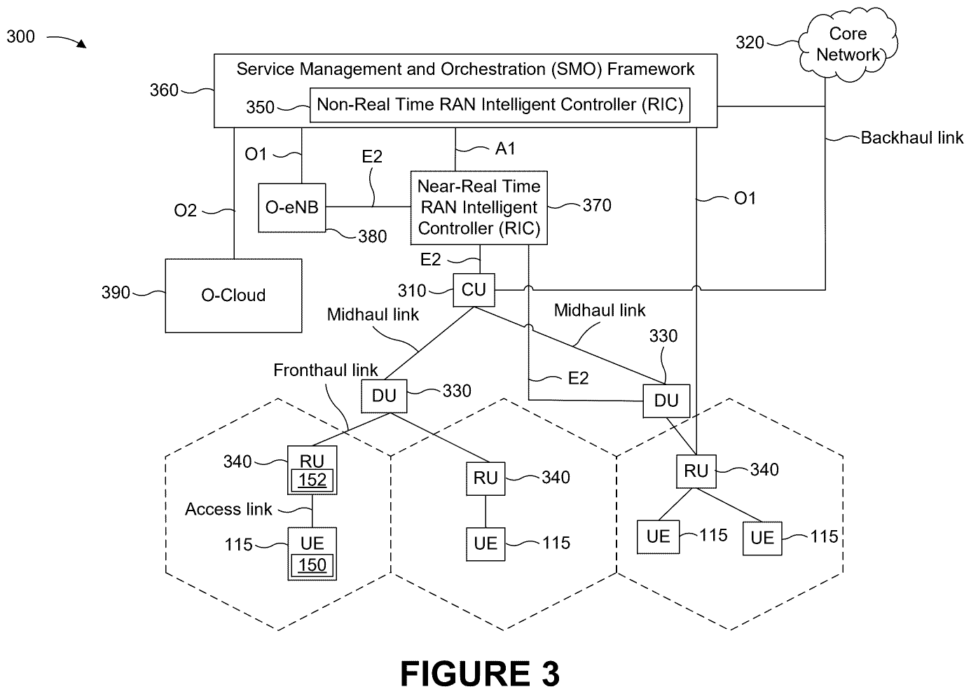

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The UE 115, the CU 310, the DU 330, the RU 340, or any other component(s) of FIG. 3 may implement one or more techniques or perform one or more operations associated with channel feedback for MU-MIMO communications, as described in more detail elsewhere herein. For example, the UEs 115 may include the feedback manager 150 and the RU 340 may include the MU-MIMO manager 152, which may manage operations to support channel feedback for MU-MIMO communications. Although shown as being included in a single UE 115 in FIG. 3, any of the UEs 115 may include the feedback manager 150, and although shown as being included in a single RU 340 in FIG. 3, any of the RUs 340, the DUs 330, the CUs 310, the Non-RT RIC 350, the SMO Framework 360, the Near-RT RIC 370, or a combination thereof, may include the MU-MIMO manager 152. The feedback manager 150 and the MU-MIMO manager 152 may direct operations of, for example, the process 600 of FIG. 6, the process 800 of FIG. 8, or other processes as described herein (alone or in conjunction with one or more other processors). In some examples, the feedback manager 150 or the MU-MIMO manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the feedback manager 150, the MU-MIMO manager 152, one or more processors of the network node 105, the UE 115, the CU 310, the DU 330, the RU 340, the Non-RT RIC 350, the SMO Framework 360, or the Near-RT RIC 370, may cause the one or more processors or the feedback manager 150 and the MU-MIMO manager 152 to perform process 600 of FIG. 6, process 800 of FIG. 8, or other processes as described herein. In some examples, executing instructions may include running the instructions, converting the instructions, compiling the instructions, and/or interpreting the instructions, among other examples.

FIG. 4 is a block diagram illustrating an example wireless communication system 400 that supports channel feedback for MU-MIMO communications in accordance with the present disclosure. In some examples, the wireless communication system 400 may implement aspects of the wireless communication network 100. The wireless communication system 400 includes the UE 115, a UE 440, and the network node 105. Although two UEs (the UE 115 and the UE 440) and one network node 105 are illustrated, in some other implementations, the wireless communication system 400 may generally include a single or three or more UEs 115, multiple network nodes 105, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 435 (hereinafter referred to collectively as “the transmitter 435”), and one or more receivers 436 (hereinafter referred to collectively as “the receiver 436”). Although referred to as a processor, the UE 115 may include one or more chips, system-on-chips (SoCs), chipsets, packages, or devices that individually or collectively constitute or include a processing system. The processing system includes one or more processors and one or more memories coupled with the one or more processors. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 402” or “the processor circuitry”).

One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions. The processor 402 may be configured to execute instructions 405 stored in the memory 404 to perform the operations described herein. In some implementations, the processor 402 includes or corresponds to one or more of the receive processor 258, the transmit processor 264, and the controller 280, and the memory 404 includes or corresponds to the memory 282, described with reference to FIG. 2. In some implementations, the processor 402, the memory 404, the instructions 405, another component of the UE 115, or a combination thereof, may include or correspond to the feedback manager 150 of FIGS. 1-3 and/or may perform the operations associated with the feedback manager 150 to support channel feedback for MU-MIMO communications.

The memory 404 may be configured to store the instructions 405, analog receiving beam information 406, bandwidth information 408, frequency component information 410, channel impulse response (CIR) information 412, and one or more threshold 414 (hereinafter referred to collectively as “the threshold 414”). The analog receiving beam information 406 indicates one or more analog beam configurations of one or more analog beams used by the UE 115 to receive signaling such as reference signals. In some examples, the reference signals may include one or more tracking reference signals (TRSs) transmitted by the network node 105 via a PDCCH. The analog receiving beam information 406 may also indicate, for each of the one or more analog beams, a quasi-colocation (QCL) relationship between the analog beam and a QCL source beam of the UE 115.

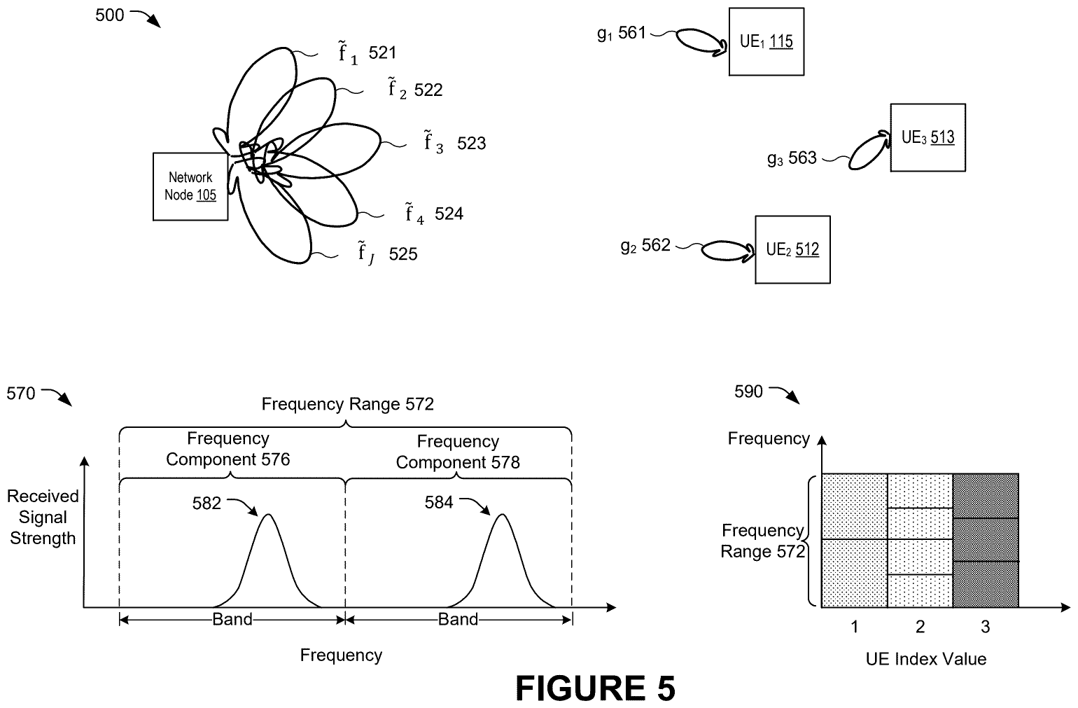

The bandwidth information 408 may indicate a frequency range (an allocated frequency), a coherence bandwidth (of a frequency component of the frequency range), a delay spread of a PDCCH transmitted by the network node 105, or a combination thereof. In some examples, the frequency range is a frequency domain allocation for the UE 115 that is allocated by the network node 105 to UEs served by the network node 105. The coherence bandwidth may indicate a bandwidth in a frequency domain of a channel between the network node 105 and the UE 115, such as a as a frequency bandwidth over which the channel remains flat or stationary in the frequency domain. The delay spread may include a delay in the time domain. It is noted that the channel between the network node 105 and the UE 115 may be a delay-Doppler based channel such that the coherence bandwidth is equal or approximately equal to an inverse of the delay spread. In some implementations, the UE 115 may estimate (or determine) the coherence bandwidth as described further herein at least with reference to FIG. 5. Additionally, or alternatively, the coherence bandwidth may be associated with a frequency selectivity of the UE 115 with respect to the frequency range.

The frequency component information 410 indicates one or more frequency components of the frequency range. In some implementations, each frequency component spans the coherence bandwidth of the channel between the network node 105 and the UE 115.

The CIR information 412 includes or indicates one or more CIR values determined by the UE 115, as further described herein. At least some of the CIR values may each include or indicate an amplitude value, a phase value, or both an amplitude value and a phase value. The CIR information 412 may include or indicate a set of CIR values for each frequency component (of the frequency range) indicated by the frequency component information 410. In some implementations, the set of CIR values for a frequency component may be associated with or determined in accordance with the reference signals received from the network node 105.

The threshold 414 may include or indicate one or more threshold values, one or more threshold ranges, or a combination thereof, that enable performance of the operations described herein. In some implementations, the threshold 414 include or indicate a threshold CIR value, such as a threshold amplitude, a threshold phase, or a combination thereof.

The transmitter 435 is configured to transmit reference signals, control information and data to one or more other devices, and the receiver 436 is configured to receive reference signals, synchronization signals, control information and data from one or more other devices. For example, the transmitter 435 may transmit signaling, control information and data to, and the receiver 436 may receive signaling, control information and data from, the network node 105. In some implementations, the transmitter 435 and the receiver 436 may be integrated in one or more transceivers. Additionally, or alternatively, the transmitter 435 or the receiver 436 may include or correspond to one or more components of the UE 115 described with reference to FIG. 2.

The UE 440 may include or correspond to the UE 115 as described herein at least with reference to FIGS. 1-4. For example, the UE 440 may include one or more components as described with reference to the UE 115. As another example, the UE 440 may be configured to perform one or more functions or operations as described with reference to the UE 115.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more transmitters 462 (hereinafter referred to collectively as “the transmitter 462”), and one or more receivers 464 (hereinafter referred to collectively as “the receiver 464”). Although referred to as a processor, the network node 105 may include one or more chips, SoCs, chipsets, packages, or devices that individually or collectively constitute or comprise a processing system. The processing system includes one or more processors and one or more memories coupled with the one or more processors. The processing system includes processor (or “processing”) circuitry in the form of one or multiple processors, microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 450” or “the processor circuitry”).

One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions. The processor 450 may be configured to execute instructions 453 stored in the memory 452 to perform the operations described herein. In some implementations, the processor 450 includes or corresponds to one or more of the receive processor 238, the transmit processor 220, and the controller 240, and the memory 452 includes or corresponds to the memory 242, described with reference to FIG. 2. In some implementations, the processor 450, the memory 452, the instructions 453, another component of the network node 105, or a combination thereof, may include or correspond to the MU-MIMO manager 152 of FIGS. 1-3 and/or may perform the operations associated with the MU-MIMO manager 152 to support channel feedback for MU-MIMO communications.

The memory 452 may be configured to store the instructions 453, analog beam information 456, and communication configuration information 458. The analog beam information 456 indicates analog beam configurations of multiple analog beams (a set of analog transmit beams) used to perform wireless communications (transmission of reference signals) at the network node 105. In some examples, the network node 105 may be configured to transmit reference signals via the set of analog transmit beams. In some implementations, the set of analog transmit beams may have or be associated with a unitary or near-unitary property such that the set of analog transmit beams span a full dimensionality of a transmit beamspace or eigenspace of the network node 105. Additionally, or alternatively, the set of analog transmit beams may include a plurality or a subset of the set of synchronization signal block (SSB) beams.

The communication configuration information 458 may include or indicate scheduling information for MU-MIMO communications, beam allocation information for MU-MIMO communications, or a combination thereof. In some examples, the communication configuration information 458 is associated with or corresponds to MU-MIMO communications between the network node 105 and the UE 115, the UE 440, or a combination thereof. As an illustrative, non-limiting example, the communication configuration information 458 can indicate that the UE 115 and the UE 440 are co-scheduled for MU-MIMO communication with the network node 105.

The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the UE 115. In some implementations, the transmitter 462 and the receiver 464 may be integrated in one or more transceivers. Additionally, or alternatively, the transmitter 462 or the receiver 464 may include or correspond to one or more components of network node 105 described with reference to FIG. 2.

In some implementations, the wireless communication system 400 implements a 5G NR network or a 6G network. For example, the wireless communication system 400 may include multiple 5G-capable UEs 115 and 440 (or 6G-capable UEs 115 and 440) and multiple 5G-capable network nodes 105 (or 6G-capable network nodes 105), such as UEs and network nodes configured to operate in accordance with a 5G NR network protocol, or a 6G network protocol, such as that defined by the 3GPP.

During operation of the wireless communication system 400, the network node 105, the UE 115, the UE 440, or a combination thereof, may perform one or more operations for supporting channel feedback for MU-MIMO communications. As part of a process of enabling wireless communications within the wireless communication system 400, and specifically MU-MIMO communications, the network node 105 may provide reference signals 470 via analog beams, such as a set of analog transmit beams, to UEs (e.g., the UE 115 and 440) within the wireless communication system 400. As described herein, the UEs may receive the reference signals 470 and provide the network node 105 with channel feedback (explicit channel feedback) to enable the network node to determine the communication configuration information 458.

In some implementations, to provide the channel feedback, each UE receives one or more tracking reference signals (TRSs) via a PDCCH transmitted by the network node 105. The UE may determine, based on the one or more TRSs, a coherence bandwidth associated with a frequency component, a delay spread of the PDCCH, or a combination thereof. Additionally, based on the coherence bandwidth or the delay spread, the UE may identify one or more frequency components of a frequency range (an allocated frequency range) via which the UE will receive the reference signals 470. An example of the UE 115 identifying one or more frequency components based on the coherence bandwidth or the delay spread, is described further herein at least with reference to FIG. 5.

In some examples, to provide the reference signals 470, the network node 105 identifies a set of analog transmit beams for use in transmitting the reference signals 470. The analog beams may be selected according to the analog beam information 456. The selected analog beams may have a unitary or near-unitary property such that the set of analog transmit beams spans a full dimensionality of a transmit beamspace or eigenspace of the network node 105. In some examples, the set of analog transmit beams includes multiple SSB beams. The network node 105 transmits the reference signals 470 via the set of analog transmit beams. In some implementations, the network node 105 may transmit an indicator to the UEs that indicates a configuration of the set of analog transmit beams. For example, the network node 105 may transmit the indicator using RRC signaling, DCI, or a MAC-CE.

Operation of each of the UE 115 and 440 to receive the reference signals 470 and provide channel feedback to the network node 105 is described herein with reference to the UE 115. Accordingly, operations described with reference to the UE 115 may also be performed by the UE 440 for the UE 440 to send channel feedback to the network node 105.

To receive the reference signals 470, the UE 115 selects one or more analog receiving beams. The selected analog receiving beam(s) may be selected in accordance with the analog receiving beam information 406. The UE 115 receives the reference signals 470 via the selected analog receiving beam(s). The UE 115 may perform one or more measurements based on the reference signals 470 to generate the CIR information 412. In some examples in which the UE 115 uses a single analog receiving beam, the UE 115 may receive the reference signals 470 with the analog receiving beam, and the UE 115 may measure a CIR value that corresponds to the received reference signals.

In some implementations, the UE 115 determines, for each frequency component of one or more frequency components (of a coherence bandwidth of a channel between the UE 115 and the network node 105) and for each analog transmit beam of the set of analog transmit beams, a CRI value of a respective reference signal of the reference signals 470. The one or more frequency components and the coherence bandwidth may be associated with or indicated by the frequency component information 410 and the bandwidth information 408, respectively. Additionally, each CIR value may include an amplitude value, a phase value, or a combination thereof. In some implementations, each CIR value is a weighted average of one or more subcarriers of the frequency component on which the reference signal is received.

In some implementations, the UE 115 selects another analog receiving beam for the UE 115 to receive the reference signals 470. The other analog beam may be selected in accordance with the analog receiving beam information 406. The UE 115 may perform one or more measurements based on the reference signals 470 received via the other analog beam to generate one or more CIR values (the CIR information 412). For example, for each analog transmit beam of the set of analog transmit beams (of the network node 105) and for each frequency component of the one or more frequency components, the UE 115 can measure, for the frequency component via the other analog receiving beam, another CIR value of the respective reference signal of the reference signals 470 transmitted on the analog beam.

To provide the network node 105 with channel feedback, the UE 115 generates a message 472 that includes CIR information 474. The CIR information 474 may include some, or all, of the CIR information 412, which indicates at least one CIR value for at least one frequency component (of the one or more frequency components) measured by the UE 115 for at least one of the reference signals 470. In some implementations, the UE 115 compares each of the CIR values of the CIR information 412 to the threshold 414 and includes the CIR values that satisfy the threshold 414 in the CIR information 474 of the message 472. For example, the CIR information 474 may include CIR values included in the CIR information 412 that are greater than or equal to the threshold 414. After generation of the message 472, the UE 115 transmits the message 472 to the network node 105. In some implementations, when the UE 115 also generates CIR values using the other analog receiving beam, the CIR information 474 may include or indicate the one or more CIR values received or measured via the other analog beam.

In some such implementations, the message 472 may optionally include an indicator 476 (as indicated by a dashed box in FIG. 4). The indicator 476 may indicate a number of frequency components identified by the UE 115, the bandwidth (associated with a frequency selectivity of the UE 115 with respect to the frequency range), the delay spread of the PDCCH, a QCL relationship between the analog receiving beam and a QCL source beam of the UE, or a combination thereof. In some implementations, when the UE 115 also generates CIR values using the other analog receiving beam, the indicator 476 may also include or indicate a QCL relationship between the other analog receiving beam and the QCL source beam of the UE 115. Additionally, or alternatively, the indicator 476 may include or indicate a number of CIR values indicated by the message 472, a total number of CIR values determined by the UE for the one or more frequency components, or a combination thereof. Although the indicator 476 is shown as being included in the message 472 with the CIR information 474, in other implementations, the indicator 476 may be transmitted separately from the message 472. In such implementations, the indicator 476 may be transmitted prior to or subsequent to transmission of the CIR information 474 in the message 472.

The network node 105 receives the message 472 from the UE 115 and identifies the CIR information 474, the indicator 476, or a combination thereof. Additionally, the network node 105 may determine the communication configuration information 458 using the CIR information 474 (and, optionally, CIR information received from another UE served by the network node 105, such as CIR information included in a message 482 received from the UE 440). The communication configuration information 458 may include or indicate, for the UE 115, UE scheduling information, beam allocation information for MU-MIMO communications, or a combination thereof.

The network node 105 generates and transmits configuration information 478 to the UE 115. The configuration information 478, such as MU-MIMO configuration information, may include or indicate the communication configuration information 458 for the UE.

The UE 115 receives the configuration information 478 and may communicate with the network node 105 in accordance with the configuration information 478. For example, the UE 115 may configure at least one beam, such as an analog beam, based on the configuration information 478 by adjusting one or more communication parameters such as a phase, an amplitude, beamforming weights, or a combination thereof. At a previously-scheduled time, the UE 115 may receive a PDCCH from the network node 105 via the at least one beam. Additionally, or alternatively, the UE 115 may receive the PDCCH from the network node 105 according to new scheduling information included in or indicated by the configuration information 478.

Although the above-described examples included the network node 105 transmitting the reference signals 470 and the UE 115 determining the CIR information 412 based on the reference signals 470, it is noted that such examples are not intended to be limiting. In other examples, the UE 115 may transmit the reference signals 470 via an analog beam associated with the UE 115, such as a UE analog transmission beam. The UE 115 may also transmit the indicator 476 to the network node 105. In such examples, the network node 105 receives the reference signals 470 from the UE 115 via a plurality of analog receive beams associated with the network node 105, and the network node 105 obtains, for each frequency component of one or more frequency components of a frequency range indicated by the indicator 476 from the UE 115, using each analog receive beam of the plurality of analog receive beams, a respective CIR value. For example, for each frequency component of the one or more frequency components, the network node 105 may obtain a respective set of CIR values based on the reference signals 470 received via the plurality of analog receive beams. The network node 105 may determine the communication configuration information 458 based on the set of CIR values, as described above for examples in which the CIR information 474 is received from the UE 115. Additionally, the network node 105 may generate and transmit the configuration information 478 to the UE 115.

As described with reference to FIG. 4, the present disclosure provides techniques for supporting channel feedback for MU-MIMO communications. In some aspects, the present disclosure provides techniques for increasing an available communication rate for MU-MIMO communication in a MU-MIMO system by providing explicit channel feedback to a network node that enables flexibility in scheduling multiple UEs for concurrent MU-MIMO communications. For example, the UE 115 may provide channel feedback, such as the CIR information 474, at an analog beam level which provides the network node 105 with an indication of a channel matrix for the UE 115. The indication of the channel matrix for the UE 115 can enable the network node 105 to co-schedule the UE 115 with other UEs for MU-communications and determine one or more beams to be used by the multiple UEs for their MU-MIMO communications that avoids interference between the multiple UEs. The explicit channel feedback at the analog beam level enables the network node 105 to perform co-scheduling and beam selection that provides a higher achievable communication rate for MU-MIMO communication in the MU-MIMO system, as compared to conventional MU-MIMO channel state feedback that is provided at a digital beamforming level in accordance with a Type-II codebook.

FIG. 5 includes diagrams illustrating aspects of another example of a wireless communication system 500 that supports channel feedback for MU-MIMO communications in accordance with the present disclosure. In some examples, the wireless communication system 500 may implement aspects of the wireless communication network 100 or the wireless communication system 400. For example, one or more operations described with reference to the wireless communication system 500 may include or correspond to one or more operations described with reference to the wireless communication network 100 or the wireless communication system 400.

The wireless communication system 500 includes the UE 115, a UE 512, a UE 513, and the network node 105. Each of the UE 512 and 513 may include or correspond to the UE 115 as described at least with reference to FIGS. 1-5 or the UE 440 as described at least with reference to FIGS. 1-4. It is noted that each of the UEs 115, 512, and 513 is depicted in FIG. 5 with a subscript that indicates a UE index value associated with the respective UE. The network node 105 is configured to serve one or more UEs, such as the UEs 115, 512, and 513. The network node 105 is configured to co-schedule two or more of the UEs 115, 512, and 513 for MU-MIMO communication. Although three UEs (the UE 115 and the UEs 512 and 513) and one network node 105 are illustrated, in some other implementations, the wireless communication system 500 may generally include another number of UEs, multiple network nodes 105, or both.

With reference to the wireless communication system 500 of FIG. 5, channel feedback and MU-MIMO configuration will be described according to the following terminology. Hᵢ denotes a channel matrix between the network node 105 and the i^{th} UE. Additionally, n=1, . . . , N indicates the n^{th} subcarrier over a frequency range for co-scheduled UEs, where N is the maximum number of subcarriers in the frequency range. In some implementations, the frequency range is a frequency domain allocation that is allocated by the network node 105, such as a frequency domain allocation for co-scheduled UEs. Further, fᵢ denotes an analog beamforming vector used by the network node 105 to transmit to the i^{th} UE, and pᵢ denotes a corresponding digital beamformer at the network node 105. The analog beamforming vector fᵢ may correspond to the set of analogy transmit beams associated with the network node 105, as described above with reference to FIG. 4. Additionally, gᵢ denotes an analog beamforming vector used by the i^{th} UE for reception from the network node 105, and qᵢ denotes a corresponding digital beamformer at the i^{th} UE. The analog beamforming vector qᵢ may correspond to the analog receiving beam, or the set of analog receive beams, associated with the UE 115, as described above with reference to FIG. 4. The digital beamforming aspects (pᵢ and qᵢ) can be implemented after the analog beamforming vectors/matrices are determined. In some implementations, digital beamforming aspects can be implemented in accordance with one or more standards, such as 3GPP specifications. A sum communication rate (averaged over the N subcarriers) with MU-MIMO in the wireless communication system 500 is given as:

$$Rate = \frac{1}{N} \cdot {\sum }_{n = 1}^{N} {\sum }_{i = 1}^{I} {log}_{2} ( 1 + \frac{{\vert {{q}_{i} ( n )}^{H} {g}_{i}^{H} {H}_{i} ( n ) {f}_{i} {p}_{i} ( n ) \vert}^{2}}{1 + {\sum }_{j \neq i} {\vert {{q}_{i} ( n )}^{H} {g}_{i}^{H} {H}_{i} ( n ) {f}_{j} {p}_{j} ( n ) \vert}^{2}} ) .$$

In some implementations, each UE is configured to identify a coherence bandwidth, represented as “Band” in FIG. 5, of a channel between the network node 105 and the respective UE. The coherence bandwidth may be associated with a frequency selectivity of the UE with respect to the frequency range for co-scheduled UEs. In some implementations, a UE determines (or estimates) the coherence bandwidth based on TRSs received as reference signals (from the network node 105?), as illustrated in FIG. 5 by a graph 570. The graph 570 depicts frequency, in Hertz (Hz), along the horizonal axis and received signal strength, in reference signal received power (RSRP) in decibel-milliwatts (dBm), along the vertical axis. The UE 115 may receive the TRSs from the network node 105 within a frequency range 572, such as a frequency domain allocation for co-scheduled UEs. The UE 115 determines a signal strength of the TRSs over the frequency range 572 to determine how approximately frequency-flat a channel (a channel vector or channel matrix) is between the UE 115 and the network node 105. In aspects, the signal strength of the TRSs over the frequency range 572 may indicate where the TRSs are strongly correlated. In the example shown in FIG. 5, the TRSs are determined to have strong correlations at the frequencies associated with large received signal strength, as indicated by arrow 582 and by arrow 584.

The UE 115 may divide the frequency range 572 by the number of strong correlations (e.g., two) to determine a size of the coherence bandwidth. For example, the strong correlation indicated by the arrow 582 is associated with a frequency component 576 of the frequency range 572, and the strong correlation indicated by the arrow 584 is associated with a frequency component 578 of the frequency range 572. In this example, there are two strong correlations, so each of the frequency components 576, 578, are associated with one-half of the total range of the frequency range 572. In other examples, there may be more frequency components that have smaller coherence bandwidths. For example, if there are three strong correlations of the TRSs in an allocated frequency range, each respective frequency component is associated with a respective coherence bandwidth having one-third of the total range. As another example, if there is only a single strong correlation of TRSs in the allocated frequency range, there may be a single frequency component that is associated with a coherence bandwidth having the same total range as the allocated frequency range.

Although the UE 115 is described as determining the coherence bandwidth in the frequency domain, in other implementations, the UE 115 may determine the coherence bandwidth in the delay domain. The channel between the UE 155 and the network node 105 may be a delay-Doppler based channel and the coherence bandwidth in the frequency domain may be equal to the inverse of a delay spread of the channel as determined in the delay domain. Accordingly, the UE 115 is capable of identifying the coherence bandwidth in the frequency domain or the delay domain, depending on UE configuration. In some implementations, the UE 115 may transmit, to the network node 105, an indicator, such as the indicator 476, that indicates the coherence bandwidth, the delay spread, a number of frequency components of the frequency range 572, or a combination thereof.

Referring to a graph 590, the graph 590 illustrates three respective coherence bandwidths identified from the frequency range 572 by the UEs 115, 512, and 513. The graph 590 depicts UE index values along the horizonal axis and frequency domain along the vertical axis. The UE index value of one (1) corresponds to the UE 115, the UE index value two (2) corresponds to the UE 512, and the UE index value three (3) corresponds to the UE 513. As shown in FIG. 5, the UE 115 has divided the frequency range 572 into two frequency components, the UE 512 has divided the frequency range 572 into four frequency components, and the UE 513 has divided the frequency range 572 into three frequency components. Thus, the UE 115 obtains CIR values for two coherence bandwidths, the UE 512 obtains CIR values for four coherence bandwidths, and the UE 513 obtains CIR values for three coherent bandwidths.

Referring back to the wireless communication system 500, the network node 105 may select a set of J beams {\tilde{f}₁, . . . , \tilde{f}_{J}}(a set of analog transmit beams). The set of J beams may be a unitary or near-unitary set of broadcast beams over the frequency range such that:

$${\sum }_{j = 1}^{J} {\tilde{f}}_{j} {\tilde{f}}_{j}^{H} \approx I$$

where I is an identity matrix. It is to be noted that unitary or near-unitarity refers to a property of the set of J beams that causes the beams to span a full dimensionality of a transmit beamspace or eigenspace of the network node 105.

With reference to the wireless communication system 500, the set of J beams used by the network node 105 includes a beam \tilde{f}₁ 521, a beam \tilde{f}₂ 522, a beam \tilde{f}₃ 523, a beam \tilde{f}₄ 524, and a beam \tilde{f}_{J} 525. Although the set of J beams is described as including five beams, in other implementations, the set of J beams can include any number of beams. In some implementations, the set of J beams include or correspond to the set of analog transmit beams via which the network node 105 transmits the reference signals 470 of FIG. 4.

In some implementations, the set of J beams may be the same as (or include) SSB beams or different than SSB beams. In some examples, the network node 105 may indicate, to each of the UEs, which beams are included in the set of J beams. For example, when the set of J beams are the same as (or include) SSB beams, the network node 105 may indicate which SSB indices constitute a unity or a near-unitary set and thus are included in the set of J beams.

Each of the UEs 115, 512, and 513 may receive reference signals (the reference signals 470 of FIG. 4) that are transmitted from the network node 105 via the set of J beams. For example, the UE 115 may select an analog receive beam g₁ 561 to receive the reference signals, the UE 512 may select an analog receive beam g₂ 562 to receive the reference signals, and the UE 513 may select an analog receive beam g₃ 563 to receive the reference signals. In some implementations, each of the UEs 115, 512, and 513 may measure, for each frequency component associated with the UE (as illustrated in the graph 590), CIR values (s_{i,j}) based on the received reference signals. For example, the i^{th} UE may use gᵢ as a receiving beam and average the received reference signal over the subcarriers in each determined frequency component of the coherence bandwidth of the i^{th} UE to produce the CIR value s_{i,j} for the frequency component, where:

$$[ {s}_{i , 1} ... {s}_{i , J} ] = \frac{1}{\vert Band \vert} {\sum }_{n ∈ \vert Band \vert} {g}_{i}^{H} {H}_{i} ( n ) {\tilde{f}}_{j}$$

The i^{th} UE computes the CIR value s_{i,j} for each beam j of the set of J beams and for each frequency component of the frequency range 572 determined by the i^{th} UE. In some implementations, the i^{th} UE can perform weighted averaging (to produce the CIR value s_{i,j}) to adjust for noise in different subcarriers. Additionally, or alternatively, each CIR value s_{i,j} may include an amplitude, a phase, or a combination thereof.

In some implementations, the i^{th} UE is configured to send one or more CIR values s_{i,j} to the network node 105 to enable the network node 105 to estimate {gᵢ^{H}Hᵢ(n), n=1, . . . , N}, where:

$$[ {s}_{i , 1} ... {s}_{i , J} ] = \frac{1}{\vert Band \vert} {\sum }_{n ∈ \vert Band \vert} {g}_{i}^{H} {H}_{i} ( n ) \cdot [ {\tilde{f}}_{1} ... {\tilde{f}}_{j} ] .$$

It is to be noted that for the network node 105 to estimate gᵢ^{H}Hᵢ(n), set of J beams {\tilde{f}₁, . . . , \tilde{f}_{J}} should have the unitary or near-unitarity property. When the network node 105 knows {gᵢ^{H}Hᵢ(n), n=1, . . . , N} for all the UEs 115, 512, 513 served by the network node 105, the network node 105 can determine which UEs can be co-scheduled based on the respective channel conditions. Additionally, or alternatively, if the network node 105 knows the {gᵢ^{H}Hᵢ(n), n=1, . . . , N} for all the UEs 115, 512, 513, the network node 105 can determine the optimal beams {fᵢ} correlated with the set of UE beams {gᵢ} to be used in MU-MIMO communication. Accordingly, the network node 105 is able to generate communication configuration information (such as the communication configuration information 458) that indicates UE scheduling information that co-schedules at least some of the UEs 115, 512, and 513, beam allocation information for MU-MIMO communications for one or more of the UEs 115, 512, or 513, or a combination thereof.

In some implementations, amplitude and phase quantization criteria may be applied by the i^{th} UE that is configured to send one or more CIR values s_{i,j} to the network node 105. Additionally, or alternatively, the i^{th} UE may be configured to selectively provide each CIR value s_{i,j} to the network node 105 if the CIR value s_{i,j} satisfies |s_{i,j}|>τ, where τ is a threshold (of the threshold 414). The threshold may be preconfigured or adaptively set by the i^{th} UE or the network node 105, and in some implementations τ may be defined in a wireless communications standard. In situations where the i^{th} UE does not send at least one CIR value s_{i,j} as part of the channel state feedback to the network node 105, the i^{th} UE may indicate to the network node 105 which CIR values are being sent (or are being omitted).

In some implementations, the i^{th} UE can be configured to report {s_{i,j}} for multiple beams {g_{i,1}, . . . , g_{i,L}}, where L is the number of analog receive beams associated with the i^{th} UE, which may be UE-specific. Additionally, L can be configured by network node 105 for a UE or can be recommended by the respective UE to the network node 105. As an illustrative example, L may be equal to two for the UE 115 if the UE 115 uses two analog receive beams. In this example, the UE 115 may use each of an analog beam g_{1,1} and an analog beam g_{1,2} to receive the references signals from the network node 105 transmitted via the set of J beams {\tilde{f}₁, . . . , \tilde{f}_{J}}. For each of the analog beams g_{1,1} and g_{1,2}, the UE 115 may determine a respective set of CIR values [s_{i,1} . . . s_{i,J}] for each of the frequency components 576 and 578. Accordingly, if J is five, the UE 115 may send up to twenty CIR values to the network node 105: five CIR values for the first frequency component for each of the J beams using the analog beam g_{1,1}, five CIR values for the second frequency component for each of the J beams using the analog beam g_{1,1}, five CIR values for the first frequency component for each of the J beams using the analog beam g_{1,2}, and five CIR values for the second frequency component for each of the J beams using the analog beam g_{1,2}. In some implementations, the UE 115 may also send an indicator to the network node 105 that indicates a QCL relationship between each analog beam g_{i,1-L} and a QCL-source beam. For example, the indicator may indicate a QCL relationship (between the analog beam g_{1,1} and the QCL-source beam) and another QCL relationship (between the analog beam g_{1,2} and the QCL-source beam). The network node 105 may determine the communication configuration information (such as the communication configuration information 458) based on CIR value(s) associated with the analog beam g_{1,1}, CIR value(s) associated with the analog beam g_{1,2}, or a combination thereof.

Although the above-described examples include the network node 105 transmitting the reference signals and the UEs 115, 512, and 513 determining respective CIR information when receiving the reference signals, it is noted that such implementations are not intended to be limiting. For example, in other implementations, one or more of the UEs 115, 512, 513 may transmit, to the network node 105, reference signals via a respective analog beam (or beams) associated with the UE. As an illustrative example, the i UE may transmit the reference signals via the analog beam gᵢ while the network node 105 receives the reference signals via the set of J beams {\tilde{f}₁, . . . , \tilde{f}_{J}}. The UE 115 may also indicate the coherence bandwidth to the network node 105, and, for each of one or more frequency components associated with the coherence bandwidth of the i^{th} UE, the network node 105 may measure a set of CIR values based on the received reference signals for each of the J beams. In some implementations, for each frequency component of the one or more frequency components associated with the coherence bandwidth of the i^{th} UE, the network node 105 may average the received reference signal over the frequency component, such that:

$$[ \begin{matrix}{\hat{s}}_{i , 1} \\ ⋮ \\ {\hat{s}}_{i , J}\end{matrix} ] = [ \begin{matrix}{\tilde{f}}_{1}^{T} \\ ⋮ \\ {\tilde{f}}_{J}^{T}\end{matrix} ] \cdot {{H}_{i} ( n )}^{T} {g}_{i}^{★} .$$

From the above equation, the network node 105 can estimate {gᵢ^{H}Hᵢ(n), n=1, . . . , N} and use it for MU-MIMO computations to generate the communication configuration information (e.g., the communication configuration information 458).

FIG. 6 is a flow diagram illustrating an example process 600 that supports channel feedback for MU-MIMO communications in accordance with the present disclosure. Operations of the process 600 may be performed by a UE, such as the UE 115 described above with reference to FIGS. 1-5, the UE 440 of FIG. 4, or the UE 512 or 513 of FIG. 5. For example, example operations (also referred to as “blocks”) of the process 600 may enable the UE to perform channel feedback for MU-MIMO communications, according to some aspects of the present disclosure.

FIG. 7 is a block diagram of an example UE 700 that supports channel feedback for MU-MIMO communications in accordance with the present disclosure. The UE 700 may be configured to perform operations, including the blocks of the process 600 described with reference to FIG. 6, to perform channel feedback for MU-MIMO communications. In some implementations, the UE 700 includes the structure, hardware, and components shown and described with reference to the UE 115 of FIG. 2 or 4. For example, the UE 700 includes the controller 280, which operates to execute logic or computer instructions stored in the memory 282, as well as controlling the components of the UE 700 that provide the features and functionality of the UE 700. The UE 700, under control of the controller 280, transmits and receives signals via wireless radios 701a-r and the antennas 252a-r. The wireless radios 701a-r include various components and hardware, as illustrated in FIG. 2 for the UE 115, including the modems 254 a-r, the MIMO detector 256, the receive processor 258, the transmit processor 264, and the TX MIMO processor 266.

As shown, the memory 282 may include the feedback manager 150, CIR information 702, and configuration information 703. Although illustrated in FIG. 7 as being included in the memory 282, in other implementations, the feedback manager 150 may be a separate component of the UE 700. The feedback manager 150 may be configured to manage one or more operations supporting channel feedback for MU-MIMO communications, such as obtaining the CIR information 702 or selecting CIR values for transmission to a network node. The CIR information 702 may include or correspond to the CIR information 412 of FIG. 4. The configuration information 703 may include or correspond to the communication configuration information 458 or the configuration information 478 of FIG. 4. The UE 700 may receive signals from or transmit signals to one or more network nodes, such as the network node 105 of FIGS. 1-5 or a network node as illustrated in FIG. 9.

Referring back to the process 600 of FIG. 6, in block 602, the UE 700 receives, from a network node via a set of analog transmit beams, a plurality of reference signals. For example, the plurality of references signals may include or correspond to the reference signals 470 of FIG. 4. The set of analog transmit beams may be associated with or indicated by the analog beam information 456 or may include or correspond to the analog beams 521-525. In some implementations, the set of analog transmit beams has a unitary or near-unitary property such that the set of analog transmit beams spans a full dimensionality of a transmit beamspace of the network node. Additionally, or alternatively, the set of analog transmit beams can include a plurality of SSB beams.

In block 604, the UE 700 obtains, for each frequency component of one or more frequency components of a frequency range, a set of CIR values associated with the received plurality of reference signals. Each frequency component spans a bandwidth of a channel between the network node and the UE 700. For example, the set of CIR values may include or correspond to the CIR information 412 or 744. The one or more frequency components or the frequency range may be associated with or indicated by the frequency component information 410. As another example, the frequency range includes or corresponds to the frequency range 572, and the one or more frequency components include or correspond to the frequency components 576 and 578. The bandwidth may be associated with or indicated by the bandwidth information 408. The bandwidth may be associated with a frequency selectivity of the UE 700 with respect to the frequency range. For example, the bandwidth may include or correspond to a coherence bandwidth as described herein.

In block 606, the UE 700 transmits, to the network node, a message that includes, for at least one frequency component of the frequency range, at least one CIR value of the set of CIR values associated with the frequency component. For example, the message may include or correspond to the message 472 or 482. In some implementations, the at least one CIR value for the at least one frequency component included in the message is greater than or equal to a threshold, such as one of the threshold 414. Additionally, or alternatively, the at least one CIR value for the at least one frequency component included in the message can include an amplitude value, a phase value, or a combination thereof.

In block 608, the UE 700 receives, from the network node, MU-MIMO configuration information in accordance with the message. In some implementations, the MU-MIMO configuration information includes communication configuration information for the UE 700. For example, the MU-MIMO configuration information and the communication configuration information may include or correspond to the configuration information 478 and the communication configuration information 458, respectively. The communication configuration information may include UE scheduling information, beam allocation information for MU-MIMO communications, or a combination thereof.

In some implementations, the UE 700 receives, from the network node, one or more TRSs via a PDCCH. For example, the one or more TRSs may include or correspond to the reference signals 470. Additionally, or alternatively, the UE 700 can determine, in accordance with the received TRSs, the bandwidth or a delay spread of the PDCCH. In some such implementations, the message includes a bandwidth indicator that indicates the bandwidth of the UE 700, delay spread information that indicates the delay spread of the PDCCH, or a combination thereof. The bandwidth indicator or the delay spread information may include or correspond to the bandwidth information 408 or the indicator 476.

In some implementations, the UE 700 selects an analog receiving beam for the UE 700. For example, the analog receiving beam may be associated with or indicated by the analog receiving beam information 406, or include or correspond to one of the analog beams 561-563. For each analog transmit beam of the set of analog transmit beams, and for each frequency component of one or more frequency components, the UE 700 can measure, via the analog receiving beam, a CIR value of a respective reference signal of the plurality of reference signals transmitted on the analog beam. As an example, the CIR value may include or correspond to the CIR information 412. In some implementations, for each analog transmit beam of the set of analog transmit beams and for each frequency component of the one or more frequency components, the CIR value of the reference signal transmitted on the analog beam and measured via the analog receiving beam is associated with a weighted average of one or more CIR values for one or more subcarriers of the frequency component on which the reference signal is received.

In some implementations, the UE 700 selects another analog receiving beam for the UE 700. For example, the other analog receiving beam may be associated with or indicated by the analog receiving beam information 406, or include or correspond to one of the analog beams 561-563. For each analog transmit beam of the set of analog transmit beams, and for each frequency component of the one or more frequency components, the UE 700 can measure, via the other analog receiving beam, another CIR value of the respective reference signal of the plurality of reference signals transmitted on the analog beam. As an example, the other CIR value may include or correspond to the CIR information 412.

In some implementations, the UE 700 transmits, to the network node, an indicator that indicates a QCL relationship between the analog receiving beam and a QCL source beam of the UE 700. Additionally, or alternatively, the UE 700 can transmit, to the network node, another indicator that indicates a QCL relationship between the other analog receiving beam and the QCL source beam of the UE 700. The indicator and the other indicator may include or correspond to the analog receiving beam information 406 or the indicator 746.

FIG. 8 is a flow diagram illustrating an example process 800 that supports channel feedback for MU-MIMO communications in accordance with the present disclosure. Operations of the process 800 may be performed by a network node, such as the network node 105 described above with reference to FIGS. 1-5. For example, example operations of the process 800 may enable the network node to perform channel feedback for MU-MIMO communications, according to some aspects of the present disclosure.

FIG. 9 is a block diagram of an example network node 900 that supports channel feedback for MU-MIMO communications in accordance with the present disclosure. The network node 900 may be configured to perform operations, including the blocks of the process 800 described with reference to FIG. 8, to perform channel feedback for MU-MIMO communications. In some implementations, the network node 900 includes the structure, hardware, and components shown and described with reference to the network node 105 of FIG. 2 or 4. For example, the network node 900 may include the controller 240, which operates to execute logic or computer instructions stored in the memory 242, as well as controlling the components of the network node 900 that provide the features and functionality of the network node 900. The network node 900, under control of the controller 240, transmits and receives signals via wireless radios 901a-t and the antennas 234a-t. The wireless radios 901a-t include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the MU-MIMO manager 152, analog beam information 902, and configuration information 903. Although illustrated in FIG. 9 as being included in the memory 242, in other implementations, the MU-MIMO manager 152 may be a separate component of the network node 900. The MU-MIMO manager 152 may be configured to manage one or more operations supporting channel feedback for MU-MIMO communications, such as transmitting reference signals and determining the configuration information 903 in accordance with at least one CIR value from the UE. The analog beam information 902 may include or correspond to the analog beam information 456 of FIG. 4. The configuration information 903 may include or correspond to the communication configuration information 458 or the configuration information 478 of FIG. 4. The network node 900 may receive signals from or transmit signals to one or more UEs, such as the UE 115 of FIGS. 1-5, the UE 440 of FIG. 4, the UE 512 or 513 of FIG. 5, or the UE 700 of FIG. 7.

Referring back to the process 800 of FIG. 8, in block 802, the network node 900 transmits, via a set of analog transmit beams, a plurality of reference signals. For example, the set of analog transmit beams may be associated with or indicated by the analog beam information 456 or may include or correspond to the analog beams 521-525. The plurality of references signals may include or correspond to the reference signals 470 of FIG. 4. In some implementations, the set of analog transmit beams has a unitary or near-unitary property such that the set of analog transmit beams spans a full dimensionality of a transmit beamspace of the network node 900. Additionally, or alternatively, the set of analog transmit beams can include one or more SSB beams.

In block 804, the network node 900 receives, from a UE, a message that includes, for at least one frequency component of one or more frequency components of a frequency range, at least one CIR value associated with the frequency component. The at least one CIR value can be obtained by the UE in association with the plurality of reference signals. For example, the message and the at least one CIR value may include or correspond to the message 472 and the CIR information 412 or 744, respectively. Additionally, each frequency component of the one or more frequency components may span a bandwidth of a channel between the network node 900 and the UE. The bandwidth may be associated with a frequency selectivity of the UE with respect to the frequency range. For example, the bandwidth may include or correspond to a coherence bandwidth as described herein. The one or more frequency components or the frequency range may be associated with or indicated by the frequency component information 410. As another example, the frequency range can include or corresponds to the frequency range 572, and the one or more frequency components can include or correspond to the frequency components 576 and 578.

In some implementations, the at least one CIR value for the at least one frequency component included in the message is greater than or equal to a threshold (of the threshold 414). Additionally, or alternatively, the at least one CIR value for the at least one frequency component included in the message can include an amplitude value, a phase value, or a combination thereof. The at least one CIR value for the at least one frequency component included in the message may also be associated with a weighted average of one or more CIR values for one or more subcarriers of the frequency component on which a respective reference signal of the plurality of reference signals is transmitted via an analog beam of the set of analog transmit beams and received by the UE via an analog receiving beam. For example, the analog receiving beam may be associated with or indicated by the analog receiving beam information 406, or include or correspond to one of the analog beams 561-563.

In block 806, the network node 900 transmits, to the UE, MU-MIMO configuration information in accordance with the message. In some implementations, the MU-MIMO configuration information includes communication configuration information for the UE. For example, the MU-MIMO configuration information and the communication configuration information may include or correspond to the configuration information 478 and the communication configuration information 458, respectively. The communication configuration information can include UE scheduling information, beam allocation information for MU-MIMO communications, or a combination thereof.

In some implementations, another UE is associated with another one or more frequency components of the frequency range. As an example, the UE and the other UE may include or correspond to the UE 115 and the UE 440, respectively. Each frequency component of the other one or more frequency components having another bandwidth of another channel between the network node 900 and the other UE. In some such implementations, the network node 900 receives, from the other UE, another message that includes, for at least one frequency component of the other one or more frequency components, another set of CIR values associated with the frequency component, the other set of CIR values obtained by the other UE in association with the set of reference signals. For example, the other message may include or correspond to the message 482. The network node 900 may determine the MU-MIMO configuration information in accordance with the message and the other message. For example, the MU-MIMO configuration information may indicate that the UE and the other UE are co-scheduled for MU-MIMO communication with the network node 900.

In some implementations, the network node 900 transmits one or more TRSs via a PDCCH. For example, the one or more TRSs may include or correspond to the reference signals 470. Additionally, or alternatively, the network node 900 may receive, from the UE, a bandwidth indicator that indicates the bandwidth of the UE, a delay spread of the PDCCH, or a combination thereof. The bandwidth indicator or the delay spread information may include or correspond to the bandwidth information 408 or the indicator 476. The network node 900 may determine the bandwidth of the UE in accordance with the bandwidth indicator.

It is noted that one or more blocks (or operations) described with reference to FIGS. 6 and 8 may be combined with one or more blocks (or operations) described with reference to another of the figures. For example, one or more blocks (or operations) of FIG. 6 may be combined with one or more blocks (or operations) of FIG. 8. As another example, one or more blocks associated with FIG. 6 or 8 may be combined with one or more blocks (or operations) associated with FIGS. 1-5. Additionally, or alternatively, one or more operations described above with reference to FIGS. 1-5 may be combined with one or more operations described with reference to FIG. 7 or 9.

In the following, further examples are described to facilitate the understanding of the disclosure.

According to Example 1, a UE for wireless communication includes a processing system that includes one or more processors and one or more memories coupled with the one or more processors, the processing system configured to cause the UE to: receive, from a network node via a plurality of analog beams, a plurality of reference signals; obtain, for each frequency component of one or more frequency components of a frequency range, a respective set of CIR values associated with the received plurality of reference signals, where each frequency component spans a bandwidth of a channel between the network node and the UE; transmit, to the network node, a message that includes, for at least one frequency component of the frequency range, at least one CIR value of the set of CIR values associated with the frequency component; and receive, from the network node, MU-MIMO configuration information in accordance with the message.

Example 2 includes the UE of Example 1, where: the plurality of analog beams has a unitary or near-unitary property such that the plurality of analog beams span a full dimensionality of a transmit beamspace of the network node; the plurality of analog beams includes a plurality of SSB beams; or a combination thereof.

Example 3 includes the UE of Example 1 or Example 2, where the processing system is further configured to cause the UE to: receive, from the network node, one or more TRSs via a PDCCH; and determine, in accordance with the received TRSs, the bandwidth or a delay spread of the PDCCH, and where: the message includes a bandwidth indicator that indicates the bandwidth of the UE, delay spread information that indicates the delay spread of the PDCCH, or a combination thereof; and the bandwidth is associated with a frequency selectivity of the UE with respect to the frequency range.

Example 4 includes the UE of any of Examples 1 to 3, where the processing system is further configured to cause the UE to: select an analog receiving beam for the UE; and, for each analog beam of the plurality of analog beams: for each frequency component of the one or more frequency components, measure, via the analog receiving beam, a CIR value of a respective reference signal of the plurality of reference signals transmitted on the analog beam.

Example 5 includes the UE of Example 4, where, for each analog beam of the plurality of analog beams and for each frequency component of the one or more frequency components, the CIR value of the respective reference signal transmitted on the analog beam and measured via the analog receiving beam is associated with a weighted average of one or more CIR values for one or more subcarriers of the frequency component on which the reference signal is received.

Example 6 includes the UE of Example 4, where the processing system is further configured to cause the UE to: select another analog receiving beam for the UE; for each analog beam of the plurality of analog beams: for each frequency component of the one or more frequency components, measure, for the frequency component via the other analog receiving beam, another CIR value of the respective reference signal of the plurality of reference signals transmitted on the analog beam; and transmit, to the network node: an indicator that indicates a QCL relationship between the analog receiving beam and a QCL source beam of the UE; and another indicator that indicates a QCL relationship between the other analog receiving beam and the QCL source beam of the UE.

Example 7 includes the UE of any of Examples 1 to 6, where the at least one CIR value for the at least one frequency component included in the message: is greater than or equal to a threshold; or includes an amplitude value, a phase value, or a combination thereof.

Example 8 includes the UE of any of Examples 1 to 7, where the MU-MIMO configuration information includes communication configuration information for the UE, the communication configuration information includes UE scheduling information, beam allocation information for MU-MIMO communications, or a combination thereof.

According to Example 9, a method of wireless communication by a UE includes: receiving, from a network node via a plurality of analog beams, a plurality of reference signals; obtaining, for each frequency component of one or more frequency components of a frequency range, a set of CIR values associated with the received plurality of reference signals, where each frequency component spans a bandwidth of a channel between the network node and the UE; transmitting, to the network node, a message that includes, for at least one frequency component of the frequency range, at least one CIR value of the set of CIR values associated with the frequency component; and receiving, from the network node, MU-MIMO configuration information in accordance with the message.

Example 10 includes the method of Example 9, where: the plurality of analog beams has a unitary or near-unitary property such that the plurality of analog beams spans a full dimensionality of a transmit beamspace of the network node; the plurality of analog beams includes a plurality of SSB beams; or a combination thereof.

Example 11 includes the method of Example 9 or Example 10 and further includes: receiving, from the network node, one or more TRSs via a PDCCH; and determining, in accordance with the received TRSs, the bandwidth or a delay spread of the PDCCH, and where: the message includes a bandwidth indicator that indicates the bandwidth of the UE, delay spread information that indicates the delay spread of the PDCCH, or a combination thereof; and the bandwidth is associated with a frequency selectivity of the UE with respect to the frequency range.

Example 12 includes the method of any of Examples 9 to 11 and further includes: selecting an analog receiving beam for the UE; and, for each analog beam of the plurality of analog beams: for each frequency component of one or more frequency components, measuring, via the analog receiving beam, a CIR value of a respective reference signal of the plurality of reference signals transmitted on the analog beam.

Example 13 includes the method of Example 12, where, for each analog beam of the plurality of analog beams and for each frequency component of the one or more frequency components, the CIR value of the reference signal transmitted on the analog beam and measured via the analog receiving beam is associated with a weighted average of one or more CIR values for one or more subcarriers of the frequency component on which the reference signal is received.

Example 14 includes the method of Example 12 and further includes: selecting another analog receiving beam for the UE; for each analog beam of the plurality of analog beams: for each frequency component of the one or more frequency components, measuring, via the other analog receiving beam, another CIR value of the respective reference signal of the plurality of reference signals transmitted on the analog beam; and transmitting, to the network node: an indicator that indicates a QCL relationship between the analog receiving beam and a QCL source beam of the UE; and another indicator that indicates a QCL relationship between the other analog receiving beam and the QCL source beam of the UE.

Example 15 includes the method of any of Examples 9 to 14, where the at least one CIR value for the at least one frequency component included in the message: is greater than or equal to a threshold; or includes an amplitude value, a phase value, or a combination thereof.

Example 16 includes the method of any of Examples 9 to 15, where the MU-MIMO configuration information includes communication configuration information for the UE, the communication configuration information includes UE scheduling information, beam allocation information for MU-MIMO communications, or a combination thereof.

According to Example 17, a network node for wireless communication includes a processing system that includes one or more processors and one or more memories coupled with the one or more processors, the processing system configured to cause the network node to: transmit, via a plurality of analog beams, a plurality of reference signals; receive, from a UE, a message that includes, for at least one frequency component of one or more frequency components of a frequency range, at least one CIR value associated with the frequency component, where each frequency component of the one or more frequency components spans a bandwidth of a channel between the network node and the UE, and where the at least one CIR value is obtained by the UE in association with the plurality of reference signals; and transmit, to the UE, MU-MIMO configuration information in accordance with the message.

Example 18 includes the network node of Example 17, where the MU-MIMO configuration information includes communication configuration information for the UE, the communication configuration information includes UE scheduling information, beam allocation information for MU-MIMO communications, or a combination thereof.

Example 19 includes the network node of Example 17 or Example 18, where: another UE is associated with another one or more frequency components of the frequency range, each frequency component of the other one or more frequency components having another bandwidth of another channel between the network node and the other UE; and the processing system is further configured to cause the network node to receive, from the other UE, another message that includes, for at least one frequency component of the other one or more frequency components, another set of CIR values associated with the frequency component, the other set of CIR values obtained by the other UE in association with the set of reference signals.

Example 20 includes the network node of Example 19, where the processing system is further configured to cause the network node to: determine the MU-MIMO configuration information in accordance with the message and the other message, and where the MU-MIMO configuration information indicates that the UE and the other UE are co-scheduled for MU-MIMO communication with the network node.

Example 21 includes the network node of any of Examples 17 to 20, where the processing system is further configured to: transmit one or more TRSs via a PDCCH; receive, from the UE, a bandwidth indicator that indicates the bandwidth of the UE, a delay spread of the PDCCH, or a combination thereof, where the bandwidth is associated with a frequency selectivity of the UE with respect to the frequency range; and determine the bandwidth of the UE in accordance with the bandwidth indicator.

Example 22 includes the network node of any of Examples 17 to 21, where: the plurality of analog beams has a unitary or near-unitary property such that the plurality of analog beams spans a full dimensionality of a transmit beamspace of the network node; the plurality of analog beams includes a plurality of SSB beams; or a combination thereof.

Example 23 includes the network node of any of Examples 17 to 22, where the at least one CIR value for the at least one frequency component included in the message: is greater than or equal to a threshold; includes an amplitude value, a phase value, or a combination thereof; or is associated with a weighted average of one or more CIR values for one or more subcarriers of the frequency component on which a respective reference signal of the plurality of reference signals is transmitted via an analog beam of the plurality of analog beams and received by the UE via an analog receiving beam.

According to Example 24, a method of wireless communication by a network node includes: transmitting, via a plurality of analog beams, a plurality of reference signals; receiving, from a UE, a message that includes, for at least one frequency component of one or more frequency components of a frequency range, at least one CIR value associated with the frequency component, where each frequency component of the one or more frequency components spans a bandwidth of a channel between the network node and the UE, and where the at least one CIR value is obtained by the UE in association with the plurality of reference signals; and transmitting, to the UE, MU-MIMO configuration information in accordance with the message.

Example 25 includes the method of Example 24, where the MU-MIMO configuration information includes communication configuration information for the UE, the communication configuration information includes UE scheduling information, beam allocation information for MU-MIMO communications, or a combination thereof.

Example 26 includes the method of Example 24 or Example 25, where: another UE is associated with another one or more frequency components of the frequency range, each frequency component of the other one or more frequency components having another bandwidth of another channel between the network node and the other UE; and the method further includes receiving, from the other UE, another message that includes, for at least one frequency component of the other one or more frequency components, another set of CIR values associated with the frequency component, the other set of CIR values obtained by the other UE in association with the set of reference signals.

Example 27 includes the method of Examples 26 and further includes: determining the MU-MIMO configuration information in accordance with the message and the other message; and where the MU-MIMO configuration information indicates that the UE and the other UE are co-scheduled for MU-MIMO communication with the network node.

Example 28 includes the method of any of Examples 24 to 27 and further includes: transmitting one or more TRSs via a PDCCH; receiving, from the UE, a bandwidth indicator that indicates the bandwidth of the UE, a delay spread of the PDCCH, or a combination thereof, where the bandwidth is associated with a frequency selectivity of the UE with respect to the frequency range; and determining the bandwidth of the UE in accordance with the bandwidth indicator.

Example 29 includes the method of any of Examples 24 to 28, where: the plurality of analog beams has a unitary or near-unitary property such that the plurality of analog beams spans a full dimensionality of a transmit beamspace of the network node; the plurality of analog beams includes one or more SSB beams; or a combination thereof.

Example 30 includes the method of any of Examples 24 to 29, where the at least one CIR value for the at least one frequency component included in the message: is greater than or equal to a threshold; includes an amplitude value, a phase value, or a combination thereof; or is associated with a weighted average of one or more CIR values for one or more subcarriers of the frequency component on which a respective reference signal of the plurality of reference signals is transmitted via an analog beam of the plurality of analog beams and received by the UE via an analog receiving beam.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single- or multi-chip processor, a DSP, an ASIC, an FPGA or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node via a plurality of analog beams, a plurality of reference signals;
obtain, for each frequency component of one or more frequency components of a frequency range, a respective set of channel impulse response (CIR) values associated with the received plurality of reference signals, wherein each frequency component spans a bandwidth of a channel between the network node and the UE;
transmit, to the network node, a message that includes, for at least one frequency component of the frequency range, at least one CIR value of the set of CIR values associated with the frequency component; and
receive, from the network node, multi-user multiple-input multiple-output (MU-MIMO) configuration information in accordance with the message.

2. The UE of claim 1, wherein:
the plurality of analog beams has a unitary or near-unitary property such that the plurality of analog beams span a full dimensionality of a transmit beamspace of the network node;
the plurality of analog beams includes a plurality of synchronization signal block (SSB) beams; or
a combination thereof.

3. The UE of claim 1, wherein the processing system is further configured to cause the UE to:
receive, from the network node, one or more tracking reference signals (TRSs) via a physical downlink control channel (PDCCH); and
determine, in accordance with the received TRSs, the bandwidth or a delay spread of the PDCCH, and
wherein:
the message includes a bandwidth indicator that indicates the bandwidth of the UE, delay spread information that indicates the delay spread of the PDCCH, or a combination thereof, and
the bandwidth is associated with a frequency selectivity of the UE with respect to the frequency range.

4. The UE of claim 1, wherein the processing system is further configured to cause the UE to:
select an analog receiving beam for the UE; and
for each analog beam of the plurality of analog beams:
for each frequency component of the one or more frequency components, measure, via the analog receiving beam, a CIR value of a respective reference signal of the plurality of reference signals transmitted on the analog beam.

5. The UE of claim 4, wherein, for each analog beam of the plurality of analog beams and for each frequency component of the one or more frequency components, the CIR value of the respective reference signal transmitted on the analog beam and measured via the analog receiving beam is associated with a weighted average of one or more CIR values for one or more subcarriers of the frequency component on which the reference signal is received.

6. The UE of claim 4, wherein the processing system is further configured to cause the UE to:
select another analog receiving beam for the UE;
for each analog beam of the plurality of analog beams:
for each frequency component of the one or more frequency components, measure, for the frequency component via the other analog receiving beam, another CIR value of the respective reference signal of the plurality of reference signals transmitted on the analog beam; and
transmit, to the network node:
an indicator that indicates a quasi-colocation (QCL) relationship between the analog receiving beam and a QCL source beam of the UE; and
another indicator that indicates a QCL relationship between the other analog receiving beam and the QCL source beam of the UE.

7. The UE of claim 1, wherein the at least one CIR value for the at least one frequency component included in the message:
is greater than or equal to a threshold; or
includes an amplitude value, a phase value, or a combination thereof.

8. The UE of claim 1, wherein the MU-MIMO configuration information includes communication configuration information for the UE, the communication configuration information includes UE scheduling information, beam allocation information for MU-MIMO communications, or a combination thereof.

9. A method of wireless communication by a user equipment (UE), comprising:
receiving, from a network node via a plurality of analog beams, a plurality of reference signals;
obtaining, for each frequency component of one or more frequency components of a frequency range, a set of channel impulse response (CIR) values associated with the received plurality of reference signals, wherein each frequency component spans a bandwidth of a channel between the network node and the UE;
transmitting, to the network node, a message that includes, for at least one frequency component of the frequency range, at least one CIR value of the set of CIR values associated with the frequency component; and
receiving, from the network node, multi-user multiple-input multiple-output (MU-MIMO) configuration information in accordance with the message.

10. The method of claim 9, wherein:
the plurality of analog beams has a unitary or near-unitary property such that the plurality of analog beams spans a full dimensionality of a transmit beamspace of the network node;
the plurality of analog beams includes a plurality of synchronization signal block (SSB) beams; or
a combination thereof.

11. The method of claim 9, further comprising:
receiving, from the network node, one or more tracking reference signals (TRSs) via a physical downlink control channel (PDCCH); and
determining, in accordance with the received TRSs, the bandwidth or a delay spread of the PDCCH, and
wherein:
the message includes a bandwidth indicator that indicates the bandwidth of the UE, delay spread information that indicates the delay spread of the PDCCH, or a combination thereof, and
the bandwidth is associated with a frequency selectivity of the UE with respect to the frequency range.

12. The method of claim 9, further comprising:
selecting an analog receiving beam for the UE; and
for each analog beam of the plurality of analog beams:
for each frequency component of one or more frequency components, measuring, via the analog receiving beam, a CIR value of a respective reference signal of the plurality of reference signals transmitted on the analog beam.

13. The method of claim 12, wherein, for each analog beam of the plurality of analog beams and for each frequency component of the one or more frequency components, the CIR value of the reference signal transmitted on the analog beam and measured via the analog receiving beam is associated with a weighted average of one or more CIR values for one or more subcarriers of the frequency component on which the reference signal is received.

14. The method of claim 12, further comprising:
selecting another analog receiving beam for the UE;
for each analog beam of the plurality of analog beams:
for each frequency component of the one or more frequency components, measuring, via the other analog receiving beam, another CIR value of the respective reference signal of the plurality of reference signals transmitted on the analog beam; and
transmitting, to the network node:
an indicator that indicates a quasi-colocation (QCL) relationship between the analog receiving beam and a QCL source beam of the UE; and
another indicator that indicates a QCL relationship between the other analog receiving beam and the QCL source beam of the UE.

15. The method of claim 9, wherein the at least one CIR value for the at least one frequency component included in the message:
is greater than or equal to a threshold; or
includes an amplitude value, a phase value, or a combination thereof.

16. The method of claim 9, wherein the MU-MIMO configuration information includes communication configuration information for the UE, the communication configuration information includes UE scheduling information, beam allocation information for MU-MIMO communications, or a combination thereof.

17. A network node for wireless communication, comprising:
a processing system that includes one or more processors and one or more memories coupled with the one or more processors, the processing system configured to cause the network node to:
transmit, via a plurality of analog beams, a plurality of reference signals;
receive, from a user equipment (UE), a message that includes, for at least one frequency component of one or more frequency components of a frequency range, at least one channel impulse response (CIR) value associated with the frequency component, wherein each frequency component of the one or more frequency components spans a bandwidth of a channel between the network node and the UE, and wherein the at least one CIR value is obtained by the UE in association with the plurality of reference signals; and
transmit, to the UE, multi-user multiple-input multiple-output (MU-MIMO) configuration information in accordance with the message.

18. The network node of claim 17, wherein the MU-MIMO configuration information includes communication configuration information for the UE, the communication configuration information includes UE scheduling information, beam allocation information for MU-MIMO communications, or a combination thereof.

19. The network node of claim 17, wherein:
another UE is associated with another one or more frequency components of the frequency range, each frequency component of the other one or more frequency components having another bandwidth of another channel between the network node and the other UE; and
the processing system is further configured to cause the network node to receive, from the other UE, another message that includes, for at least one frequency component of the other one or more frequency components, another set of CIR values associated with the frequency component, the other set of CIR values obtained by the other UE in association with the set of reference signals.

20. The network node of claim 19, wherein the processing system is further configured to cause the network node to determine the MU-MIMO configuration information in accordance with the message and the other message, and wherein the MU-MIMO configuration information indicates that the UE and the other UE are co-scheduled for MU-MIMO communication with the network node.

21. The network node of claim 17, wherein the processing system is further configured to:
transmit one or more tracking reference signals (TRSs) via a physical downlink control channel (PDCCH);
receive, from the UE, a bandwidth indicator that indicates the bandwidth of the UE, a delay spread of the PDCCH, or a combination thereof, wherein the bandwidth is associated with a frequency selectivity of the UE with respect to the frequency range; and
determine the bandwidth of the UE in accordance with the bandwidth indicator.

22. The network node of claim 17, wherein:
the plurality of analog beams has a unitary or near-unitary property such that the plurality of analog beams spans a full dimensionality of a transmit beamspace of the network node;
the plurality of analog beams includes a plurality of synchronization signal block (SSB) beams; or
a combination thereof.

23. The network node of claim 17, wherein the at least one CIR value for the at least one frequency component included in the message:
is greater than or equal to a threshold;
includes an amplitude value, a phase value, or a combination thereof; or
is associated with a weighted average of one or more CIR values for one or more subcarriers of the frequency component on which a respective reference signal of the plurality of reference signals is transmitted via an analog beam of the plurality of analog beams and received by the UE via an analog receiving beam.

24. A method of wireless communication by a network node, comprising:
transmitting, via a plurality of analog beams, a plurality of reference signals;
receiving, from a user equipment (UE), a message that includes, for at least one frequency component of one or more frequency components of a frequency range, at least one channel impulse response (CIR) value associated with the frequency component, wherein each frequency component of the one or more frequency components spans a bandwidth of a channel between the network node and the UE, and wherein the at least one CIR value is obtained by the UE in association with the plurality of reference signals; and
transmitting, to the UE, multi-user multiple-input multiple-output (MU-MIMO) configuration information in accordance with the message.

25. The method of claim 24, wherein the MU-MIMO configuration information includes communication configuration information for the UE, the communication configuration information includes UE scheduling information, beam allocation information for MU-MIMO communications, or a combination thereof.

26. The method of claim 24, wherein:
another UE is associated with another one or more frequency components of the frequency range, each frequency component of the other one or more frequency components having another bandwidth of another channel between the network node and the other UE; and
the method further comprises receiving, from the other UE, another message that includes, for at least one frequency component of the other one or more frequency components, another set of CIR values associated with the frequency component, the other set of CIR values obtained by the other UE in association with the set of reference signals.

27. The method of claim 26, further comprising:
determining the MU-MIMO configuration information in accordance with the message and the other message; and
wherein the MU-MIMO configuration information indicates that the UE and the other UE are co-scheduled for MU-MIMO communication with the network node.

28. The method of claim 24, further comprising:
transmitting one or more tracking reference signals (TRSs) via a physical downlink control channel (PDCCH);
receiving, from the UE, a bandwidth indicator that indicates the bandwidth of the UE, a delay spread of the PDCCH, or a combination thereof, wherein the bandwidth is associated with a frequency selectivity of the UE with respect to the frequency range; and
determining the bandwidth of the UE in accordance with the bandwidth indicator.

29. The method of claim 24, wherein:
the plurality of analog beams has a unitary or near-unitary property such that the plurality of analog beams spans a full dimensionality of a transmit beamspace of the network node;
the plurality of analog beams includes one or more synchronization signal block (SSB) beams; or
a combination thereof.

30. The method of claim 24, wherein the at least one CIR value for the at least one frequency component included in the message:
is greater than or equal to a threshold;
includes an amplitude value, a phase value, or a combination thereof; or
is associated with a weighted average of one or more CIR values for one or more subcarriers of the frequency component on which a respective reference signal of the plurality of reference signals is transmitted via an analog beam of the plurality of analog beams and received by the UE via an analog receiving beam.
